(19) United States
(12) Patent Application Publication
(10) Pub. No.: US 2022/0046896 A1
(43) Pub. Date: Feb. 17, 2022

(54) PET COLLAR AND PET INFORMATION COMBINATION ASSEMBLY

(71) Applicant: Nicole Patterson, Detroit, MI (US)

(72) Inventor: Nicole Patterson, Detroit, MI (US)

(21) Appl. No.: 16/990,019

(22) Filed: Aug. 11, 2020

(51) Int. Cl. A01K 11/00; A01K 27/00

(52) U.S. Cl. CPC A01K 11/00; A01K 27/001

(57) ABSTRACT

A pet collar and pet information combination assembly includes a strap that has a first end and a second end. A clasp is attached to the first and second ends. The clasp includes a first section attached to the first end and a second section attached to the second end. The first and second sections are releasably secured to each other to form a closed loop. A panel is positioned on an outer surface of the strap. A barcode is positioned on the panel and has decodable information positioned thereon related to an animal fitted for the strap.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pet identification device and more particularly pertains to a new pet identification device for assisting a person in quickly determining who owns a pet with barcode technology so that it can be returned to its owner. This will prevent the need to attempt to see hard to read tags as well as obviate the need to bring an animal to a veterinarian clinic so that an under the skin pet chip can be scanned with a specialized scanner.

### (2) Description of Related Art Including Information Disclosed Under 37 CFR 1.97 and 1.98

The prior art relates to pet identification devices that are used to assist a person in finding the owner of a lost pet.

### BRIEF SUMMARY OF THE INVENTION

An embodiment of the disclosure meets the needs presented above by generally comprising a strap that has a first end and a second end. A clasp is attached to the first and second ends. The clasp includes a first section attached to the first end and a second section attached to the second end. The first and second sections are releasably secured to each other to form a closed loop. A panel is positioned on an outer surface of the strap. A barcode is positioned on the panel and has decodable information positioned thereon related to an animal fitted for the strap.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of a pet collar and pet information combination assembly according to an embodiment of the disclosure.

FIG. 2 is a rear view of an embodiment of the disclosure.

FIG. 3 is a front view of an embodiment of the disclosure.

FIG. 4 is an isometric in-use view of an embodiment of the disclosure.

FIG. 5 is a schematic view of an embodiment of the disclosure.

### DETAILED DESCRIPTION OF THE INVENTION

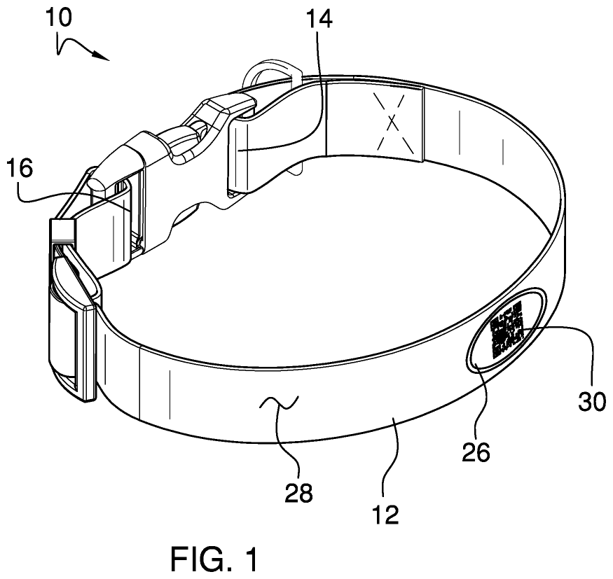

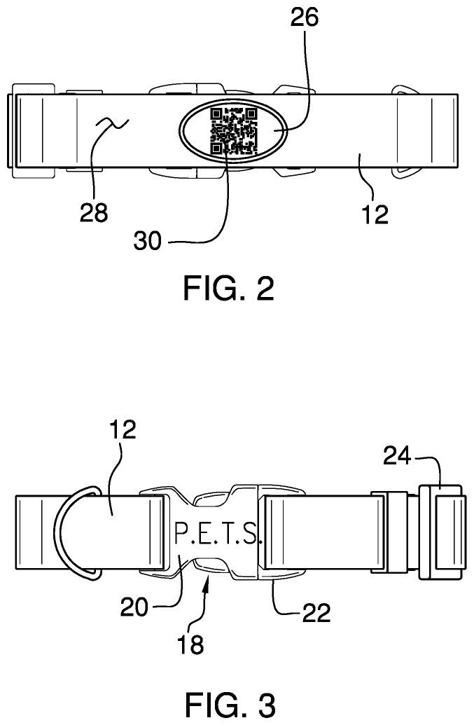

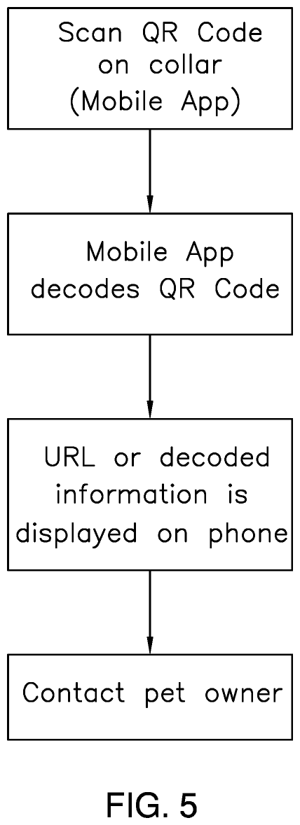

With reference now to the drawings, and in particular to FIGS. 1 through 5 thereof, a new pet identification device embodying the principles and concepts of an embodiment of the disclosure and generally designated by the reference numeral 10 will be described.

As best illustrated in FIGS. 1 through 5, the pet collar and pet information combination assembly 10 generally comprises a strap 12 having a first end 14 and a second end 16. The strap 12 may include any conventional flexible strapping material used for pet collars and in particular collars worn by felines and canines. The strapping material may therefore include woven natural and synthetic straps, leather materials, plastics, elastomers and the like. A length of the strap 12 will typically be between 6 inches and 24 inches long and may include a length adjuster such as a conventional slip lock 24 or tri-glide.

A clasp 18 is attached to the first 14 and second 16 ends, the clasp 18 includes a first section 20 attached to the first end 14 and a second section 22 attached to the second end 16. The first 14 and second 16 sections are releasably secured to each other to form a closed loop. The clasp 18 will typically be comprised of a plastic or composite material.

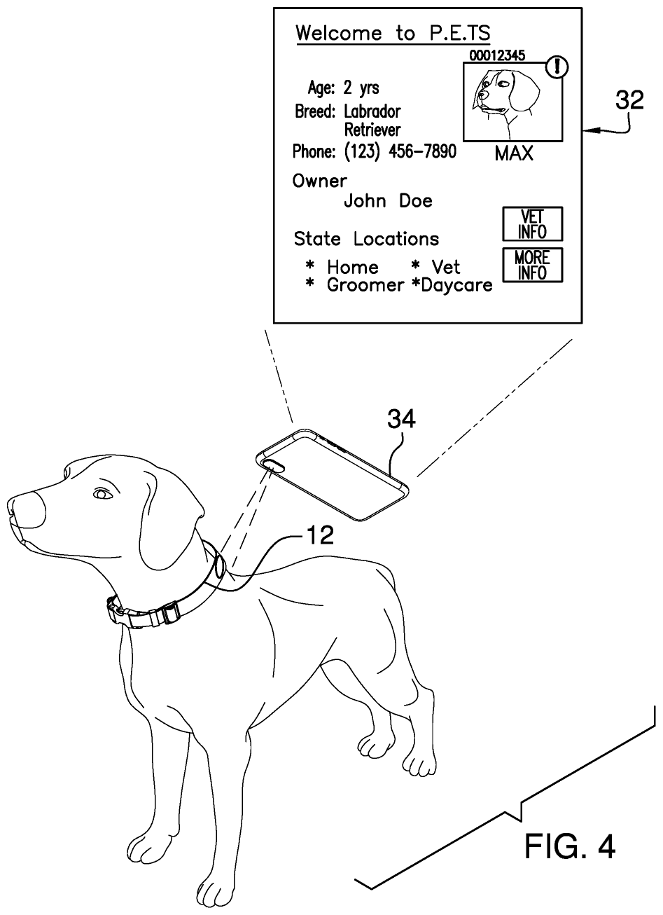

A panel 26 is positioned on an outer surface 28 of the strap 12 and a barcode 30 is positioned on the panel 26. The barcode 30 has decodable information 32 positioned thereon related to an animal fitted for the strap 12. The information may be formed into the barcode 30 itself, particularly if the barcode 30 is a two-dimensional barcode, which can be read by a barcode reader. Two-dimensional barcodes such as those utilizing QR code is ubiquitous as are readers for the same and such is the preferred type of barcode to be utilized herein. The information 32 contained therein may include information particularly related to the pet wearing the collar including, for example, a phone number for the owner of the pet and other relevant pet information as shown in FIG. 4. Alternatively, the barcode 30 may provide a website address which contains the same pertinent information 32. The barcode 30 can typically be read by an application on a cellular phone 34, for example, such that the pet need not be taken to a veterinarian for reading an embedded microchip. Also, the assembly 10 may be replaced as needed with a newly created barcode 30 should the information 32 on the barcode 30 no longer be accurate. Because the barcode 30 can be created easily, the accessibility of identification means is greater than with microchipping actions taken by a veterinarian.

The panel 26 will preferably be comprised of a rigid material wherein the barcode 30 is etched into the panel 26. This will prevent the barcode 30 from fading due to the elements and from pet interaction with the collar and other animals. The rigid material is preferably a metallic material though plastics and carbon composite materials could also be utilized.

In use, a barcode 30 is created having embedded information that can either be decoded directly for pet information or directs a scanner of the barcode 30 to a website address containing the pet information. The person scanning the barcode 30 can then contact the owner of the pet to return the pet to the owner.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An animal identifying collar assembly:
a strap having a first end and a second end;
a clasp being attached to the first and second ends, the clasp including a first section attached to the first end and a second section attached to the second end, the first and second sections being releasably secured to each other to form a closed loop;
a panel being positioned on an outer surface of the strap;
a barcode being positioned on the panel, the barcode having decodable information positioned thereon related to an animal fitted for the strap.

2. The animal identifying collar assembly according to claim 1, wherein the barcode is a two-dimensional barcode.

3. The animal identifying collar assembly according to claim 1, wherein the panel is comprised of a rigid material.

4. The animal identifying collar assembly according to claim 3, wherein the barcode is etched into the panel.

5. The animal identifying collar assembly according to claim 4, wherein the rigid material being a metallic material.

6. An animal identifying collar assembly:
a strap having a first end and a second end;
a clasp being attached to the first and second ends, the clasp including a first section attached to the first end and a second section attached to the second end, the first and second sections being releasably secured to each other to form a closed loop;
a panel being positioned on an outer surface of the strap;
a barcode being positioned on the panel, the barcode having decodable information positioned thereon related to an animal fitted for the strap, the barcode being a two-dimensional barcode; and
the panel being comprised of a rigid material, the barcode being etched into the panel, the rigid material being a metallic material.
